(19) United States
(12) Patent Application Publication
(10) Pub. No.: US 2005/0088023 A1
(43) Pub. Date: Apr. 28, 2005

(54) In-line seat recliner assembly

(76) Inventor: Tomas Hinojos, Harrison Township, MI (US)

Correspondence Address: HARNESS, DICKEY & PIERCE, P.L.C., P.O. BOX 828, BLOOMFIELD HILLS, MI, 48303, US

(21) Appl. No.: 10/692,309

(22) Filed: Oct. 22, 2003

(51) Int. Cl. B60N 2/02

(52) U.S. Cl. 297/361.1

(57) ABSTRACT

An in-line seat recliner assembly for controllably adjusting the angular position of a seat back relative to a seat bottom is provided. The seat recliner assembly includes a drive assembly rotatable about a first axis and a driven assembly rotatable about a second axis, which is generally parallel to the first axis. A transmission assembly is disposed between the drive assembly and the driven assembly for transferring torque therebetween. The driven assembly is adapted to be coupled with either the seat back or the seat bottom for adjusting the angular position of the seat back relative to the seat bottom. The recliner assembly also includes a housing for enclosing the transmission assembly, and for connecting said recliner assembly to the other of the seat back and the seat bottom.

### FIELD OF THE INVENTION

The present invention relates to seat recliner assemblies, and more particularly to an in-line seat recliner assembly.

### BACKGROUND OF THE INVENTION

In a conventional seat recliner assembly, a motor drives one or more actuator cables that, in turn, drive respective transmission assemblies disposed beneath a seat bottom near the sides of the seat. Each transmission assembly includes an input shaft and an output shaft operably connected to an arm for reclining a seat back. Typically, the input shafts rotate about an axis perpendicular to the output shafts. Therefore, the motor must be positioned beneath the seat bottom between the two transmission assemblies.

Recent automotive system innovations have provided vehicle manufacturers with a need to mount additional vehicle system components beneath the seat bottom. Such system components include vehicle control modules, heating systems, air conditioning systems, ductwork for rear seat passengers, and occupant sensors for air bag systems. Hence, flexibility in positioning the motor relative the recliner transmission assemblies would ease space consumption issues arising from the desire to position vehicle system components below the seat. Current recliner transmission assemblies, however, are hampered in their ability to accommodate these vehicle system components below the seat because their design requires receiving an input shaft through a sidewall of the transmission housing, thus limiting the location of the motor in relation to the transmission.

### SUMMARY OF THE INVENTION

An in-line seat recliner assembly is provided including a motor, an actuator cable, and a transmission. The transmission includes input and output shafts having substantially parallel rotational axes. This enables the actuator cable to plug into the transmission through a front or rear wall, rather than a side wall, thus allowing the motor to be positioned forward or rearward the transmission assembly. This creates more usable space beneath the seat bottom for storing other vehicle system components.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of an in-line seat recliner system in accordance with the present invention.

FIG. 2 is a perspective view of an in-line transmission assembly in accordance with the seat recliner system of the present invention.

FIG. 3 is a perspective view of the in-line transmission assembly of FIG. 2 with the outer housing removed therefrom.

FIG. 4 is an exploded perspective view of the in-line transmission assembly of FIG. 2.

FIG. 5 is a schematic view of a vehicle seat including an in-line seat recliner system in accordance with the present invention.

### DETAILED DESCRIPTION OF THE PREFERRED EMBODIMENTS

The following description of the preferred embodiment is merely exemplary in nature and is in no way intended to limit the invention, its application, or uses.

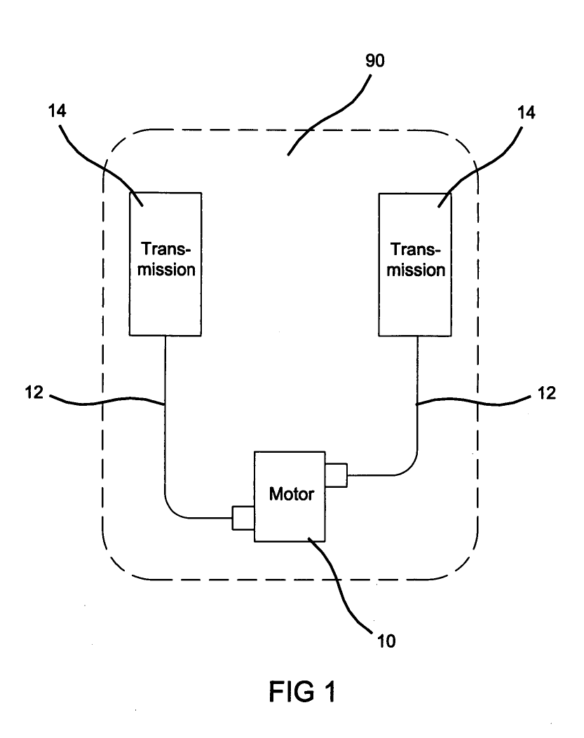

With reference to FIG. 1, a preferred embodiment of an in-line seat recliner assembly is provided including a bidirectional electric motor 10, a pair of actuator cables 12, and a pair of transmission assemblies 14 positioned rearward the motor 10. For the motor 10 to drive the transmission assemblies 14, the motor 10 is coupled to drive the actuator cables 12 and the actuator cables 12 are coupled to the transmission assemblies 14.

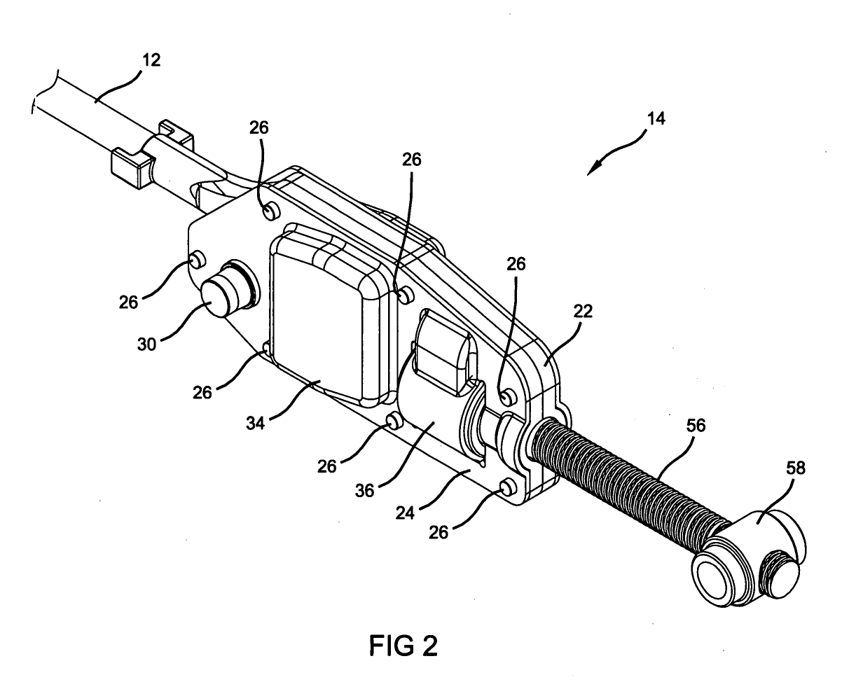

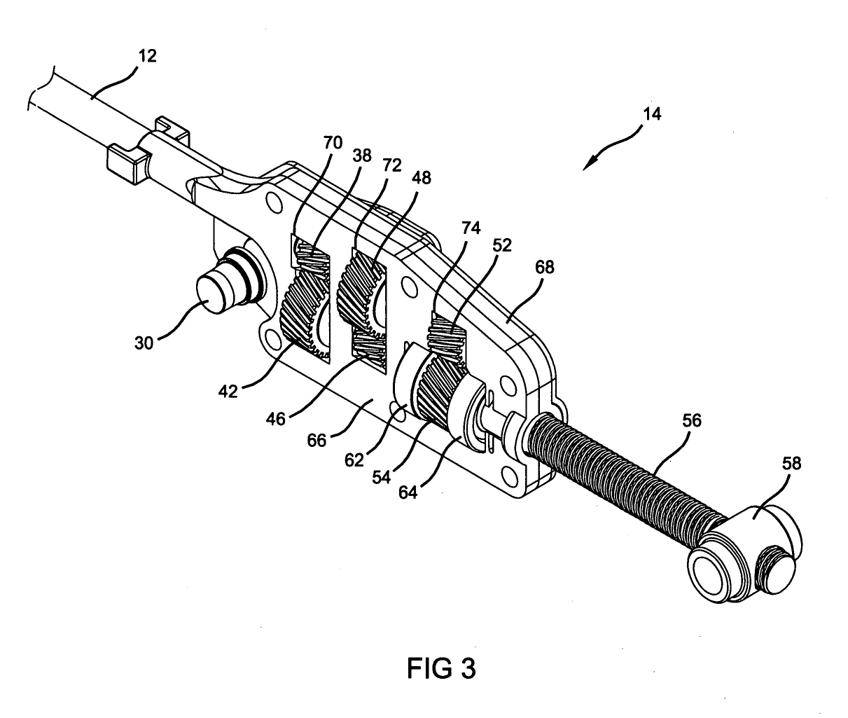

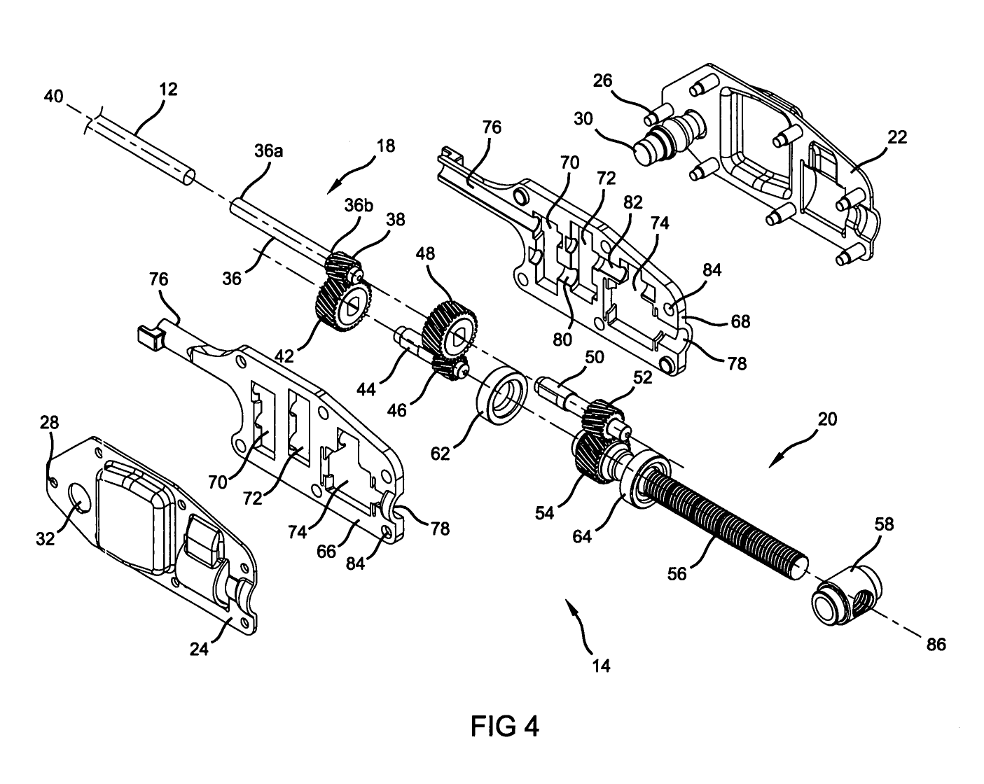

Now with specific reference to FIGS. 2-4, an in-line transmission assembly 14 in accordance with the seat recliner assembly of the present invention is presented. The transmission assembly 14 includes a housing assembly, a drive assembly, and a driven assembly. The housing assembly includes a first housing plate 22 and a second housing plate 24. The first housing plate 22 includes a plurality of connecting pins 26 and the second housing plate 24 includes a plurality of connecting apertures 28 for receiving the connecting pins 26 and sealingly connecting the first housing plate 22 to the second housing plate 24. The first housing plate 22 further includes a mounting pin 30 and the second housing plate 24 includes a mounting aperture 32 for receiving the mounting pin 30, thereby enabling the housing assembly to be pivotally mounted to a seat bottom 90. The housing assembly is further constructed to include a gear train cavity 34 and a load absorbing cavity 36. The first and second housing plates 22, 24 house a portion of the drive assembly, a portion of the driven assembly, and a gear train (shown in more detail in FIGS. 3 and 4).

The drive assembly includes an actuator cable 12 and an input shaft 36, which rotates about an input axis 40. The input shaft 36 includes a first end 36a adapted to be connected to the actuator cable 12, and a second end 36b adapted to drive a first helical gear 38. The first helical gear 38 rotates about the input axis 40 and is adapted to meshingly engage a second helical gear 42, which rotates about an output axis 86 that is substantially parallel to the input axis 40. The second helical gear 42 is mounted to an upstream end of a first gear shaft 44 and a third helical gear 46 is mounted to a downstream end of the first gear shaft 44. The first gear shaft 44 and third helical gear 46, therefore, rotate about the output axis 86. The third helical gear 46 is adapted to meshingly engage a fourth helical gear 48, which rotates about the input axis 40 and is attached to an upstream end of a second gear shaft 50. The second gear shaft 50 rotates about the input axis 40 and drives a fifth helical gear 52, which is attached to a downstream end of the second gear shaft 50. The fifth helical gear 52 is adapted to meshingly engage a sixth helical gear 54, which rotates about the output axis 86 and is fixedly attached to an upstream end of a driven assembly.

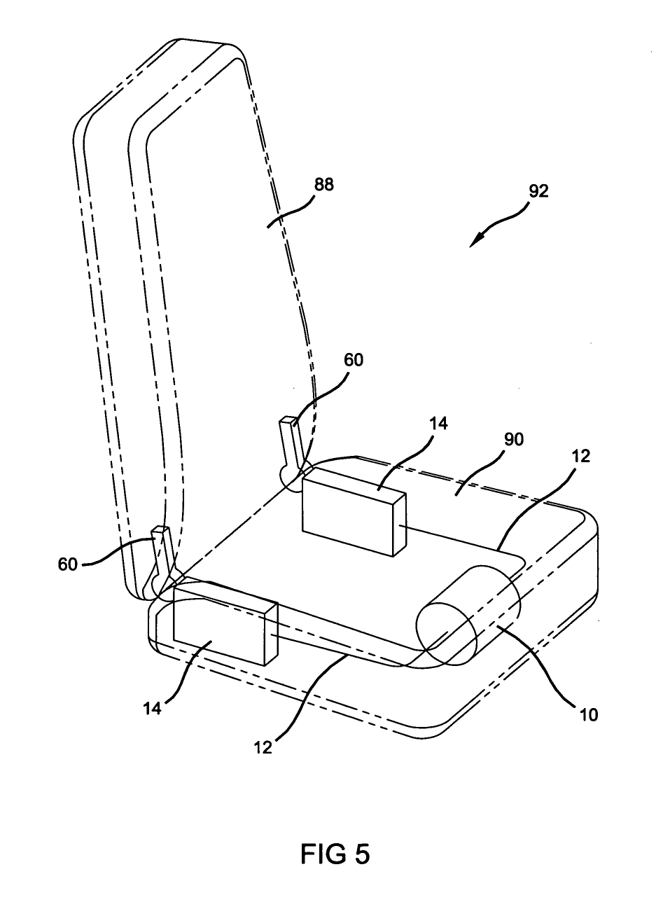

The driven assembly includes a threaded output shaft 56, a screw nut 58, and an arm 60 (shown in FIG. 5) having one end pivotally connected to the screw nut 58 and another end fixedly attached to a seat back 88 (shown in FIG. 5). Furthermore, the driven assembly includes first and second roller bearings 62, 64 for maintaining alignment between the gear train and the driven assembly. The first roller bearing 62 is disposed on the output shaft 56 adjacent an upstream side of the sixth helical gear 54, and the second roller bearing 64 is disposed about the output shaft 56 adjacent a downstream side of the sixth helical gear 54.

With continued reference to FIGS. 3 and 4. The transmission assembly 14 further includes an alignment assembly having a first alignment plate 66 and a second alignment plate 68. The alignment plates 66, 68 each contain associated first gear apertures 70, second gear apertures 72, load bearing apertures 74, input channels 76, output channels 78, first gear shaft channels 80, second gear shaft channels 82, and mounting pin apertures 84 adapted to receive the plurality of mounting pins 26 disposed on the first housing plate 22.

The first and second alignment plates 66, 68 cooperate to maintain alignment of the input shaft 36, the helical gears 38, 42, 44, 46, 48, 52, 54, the first gear shaft 44, the second gear shaft 50, the output shaft 56 and the roller bearings 62, 64. The input channels 76 cooperate to receive and support the input shaft 36. The first gear apertures 70 cooperate to receive and support the first and second helical gears 38, 42. The second gear apertures 72 cooperate to receive and support the third and fourth helical gears 46, 48. The load absorbing apertures 74 cooperate to receive and support the roller bearings 62, 64, and the fifth and sixth helical gears 52, 54. The load absorbing apertures further cooperate with the bearings 62, 64 to provide a crush zone for absorbing rearward impacting loads to the transmission assembly 14. The output channels 78 cooperate to receive and support the output shaft 56. The first gear shaft channels 80 cooperate to receive and support the first gear shaft 44. The second gear shaft channels 82 cooperate to receive and support the second gear shaft 50.

With reference to FIGS. 3 and 5, during operation, the motor 10 drives the actuator cable 12. The actuator cable 12 drives the input shaft 36 along the input axis 40, thereby driving the first helical gear 38. The first helical gear 38 engages the second helical gear 42, thereby driving the first gear shaft 44 and the third helical gear 46 about an output axis 86 that is substantially parallel to the input axis 40. The third helical gear 46 engages the fourth helical gear 48, thereby driving the second gear shaft 50 and the fifth helical gear 52 about the input axis 40. The fifth helical gear 52 engages the sixth helical gear 54, thereby driving the output shaft 56 about the output axis 86. The output shaft 56 causes the screw nut 58 to threadably move in one of two directions along the output shaft 56. The direction of movement of the screw nut 58 depends on the direction of rotation of the motor 10.

It should be appreciated that while the above-described embodiment includes a driven assembly having a threaded output shaft 56 and a screw nut 58, a driven assembly including a toothed rod and a pinion gear, as is well known in the art, is also intended to be within the scope of this invention.

Now with specific reference to FIG. 5. A vehicle seat assembly 92 is provided including an embodiment of the seat recliner assembly of the present invention. The vehicle seat assembly 92 generally includes a seat bottom 90 and a seat back 88 pivotally connected to the seat bottom 90. A recliner assembly including a motor 10, a pair of actuator cables 12, and a pair of transmission assemblies 14 is attached beneath the seat bottom 90. The transmission assemblies 14 are operably connected to rotate a pair of seat arms 60. Thus, when the motor 10 is activated, the actuator cables 12 drive the transmission assemblies 14, thereby adjusting the angle of the seat back 88 relative the seat bottom 90.

The description of the invention is merely exemplary in nature and, thus, variations that do not depart from the gist of the invention are intended to be within the scope of the invention. Such variations are not to be regarded as a departure from the spirit and scope of the invention.

1. An in-line seat recliner assembly for controllably adjusting the angular position of a seat back relative to a seat bottom, said recliner comprising:
a drive assembly having an input axis;
a driven assembly adapted to be coupled with one of the seat back and the seat bottom and having an output axis generally parallel to said input axis; and
a transmission assembly disposed between and operably connecting said drive assembly and said driven assembly.

2. The seat recliner assembly of claim 1, wherein said drive assembly includes an actuator.

3. The seat recliner assembly of claim 2, wherein said actuator includes a bidirectional electric motor.

4. The seat recliner assembly of claim 2, wherein said drive assembly includes an actuator cable driven by said actuator.

5. The seat recliner assembly of claim 3, wherein said drive assembly includes an input shaft driven by said actuator cable and rotatable about said input axis.

6. The seat recliner assembly of claim 1, wherein said driven assembly includes a threaded output shaft rotatable about said output axis and a screw nut disposed thereon, wherein said screw nut is reciprocally and threadably moveable along said threaded output shaft.

7. The seat recliner assembly of claim 6, wherein said driven assembly further includes a seat arm having a first end attached to the seat back and a second end pivotally connected to said screw nut.

8. The seat recliner assembly of claim 1, wherein said transmission assembly includes a gear train having a first helical gear driving a second helical gear, said first helical gear rotatable about said input axis, and said second helical gear rotatable about said output axis.

9. The seat recliner assembly of claim 1, further comprising an alignment assembly.

10. The seat recliner assembly of claim 9, wherein said alignment assembly includes first and second alignment plates.

11. The seat recliner assembly of claim 1, further comprising a housing for retaining said gear train.

12. The seat recliner assembly of claim 11, wherein said housing is mountable to connect said recliner assembly to the other of the seat back and the seat bottom.

13. A vehicle seat assembly comprising:
a seat bottom;
a seat back coupled with said seat bottom and capable of pivotal adjustment relative to said seat bottom;
a seat recliner assembly comprising a drive assembly having an input axis, a driven assembly adapted to be coupled with one of said seat back and said seat bottom and having an output axis generally parallel to said input axis, and a transmission assembly disposed between and operably connecting said drive assembly and said driven assembly.

14. The vehicle seat assembly of claim 13, further comprising a housing for retaining said transmission assembly.

15. The vehicle seat assembly of claim 14, wherein said housing is mountable to connect said seat recliner assembly to the other of said seat back and said seat bottom.

16. The vehicle seat assembly of claim 13, wherein said drive assembly includes an actuator.

17. The vehicle seat assembly of claim 16, wherein said actuator includes a bidirectional electric motor.

18. The vehicle seat assembly of claim 16, wherein said drive assembly includes an actuator cable driven by said actuator.

19. The vehicle seat assembly of claim 18, wherein said drive assembly includes an input shaft driven by said actuator cable and rotatable about said input axis.

20. The vehicle seat assembly of claim 13, wherein said driven assembly includes a threaded output shaft rotatable about said output axis and a screw nut disposed thereon, wherein said screw nut is threadably moveable along said threaded output shaft from a first position to a second position.

21. The vehicle seat assembly of claim 20, wherein said driven assembly further includes a seat arm having a first end attached to the seat back and a second end pivotally connected to said screw nut.

22. The vehicle seat assembly of claim 13, wherein said transmission assembly includes a gear train having a first helical gear driving a second helical gear, said first helical gear having a rotational axis common with said input axis, and said second helical gear having a rotational axis common with said output axis.

23. The vehicle seat assembly of claim 13, further comprising an alignment assembly.

24. The vehicle seat assembly of claim 23, wherein said alignment assembly includes first and second alignment plates.
